(19) United States
(12) Patent Application Publication
(10) Pub. No.: US 2002/0125419 A1
(43) Pub. Date: Sep. 12, 2002

(54) Solid-state organic maser

(76) Inventor: Philip S. Callahan, Cedar Crest, NM (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/066,807

(22) Filed: Feb. 6, 2002

Related U.S. Application Data
(60) Provisional application No. 60/266,466, filed on Feb. 6, 2001.

(51) Int. Cl. H01S 1/00

(52) U.S. Cl. 250/251

(57) ABSTRACT

A solid-state, paramagnetic-diamagnetic maser for controlling the amplification and direction of electromagnetic emissions from a molecular control system, such as insect pheromones. The solid-state maser includes a paramagnetic layer of, for example, a mixture of andosite, basalt and granite. The paramagnetic layer is disposed onto a diamagnetic base. A burlap or hairy cloth impregnated with the molecular control system is placed over the paramagnetic layer, such that the paramagnetic energy amplifies the molecular control system to produce coherent or semi-coherent electromagnetic emissions. The molecular control system can be a semiochemical (such as, insect pheromones), garlic scent, perfume, deodorant, air freshener, similar molecules, infrared coded emissions from any system that controls or effects living organisms, and the like. The solid-state maser of the present invention is an organic and biodegradable device that is tuned and modulated by existing and naturally occurring atomospheric frequencies. Moreover the device provides a highly efficient and effective solution for pest control and improving plant growth, without having to exterminate the pests or distribute chemicals that may harm the environment or increase health risks for humans.

### CROSS-REFERENCE TO RELATED APPLICATIONS

This application claims priority to U.S. Provisional Application No. 60/266,466, filed Feb. 6, 2001, which is incorporated by reference herein in its entirety.

### STATEMENT REGARDING FEDERALLY-SPONSORED RESEARCH AND DEVELOPMENT

Not applicable.

### REFERENCE TO MICROFICHE APPENDIX/SEQUENCE LISTING/TABLE/COMPUTER PROGRAM LISTING APPENDIX (SUBMITTED ON A COMPACT DISC AND AN INCORPORATION-BY-REFERENCE OF THE MATERIAL ON THE COMPACT DISC)

Not applicable.

### BACKGROUND OF THE INVENTION

1. Field of the Invention

The present invention is directed to a device for producing maser-like emissions and a method of fabrication. More particularly, the present invention relates to the stimulation of maser-like emissions from scents or other molecular control systems.

1.Background Art

Recent years have imposed major challenges on efforts to juxtapose effective pest control with sustaining the delicate balance between humans and nature. Mites, ticks, mosquitos, flies, other insects, worms, rodents and similar pests are firmly integrated into the Earth's ecosystem. They interact with the environment, and thus humans, as they search for food and shelter. Insects, for example, may be attracted to a number of naturally occurring phenomena, such as carbon dioxide resident in a person's breath, the makeup of a person's perspiration or the surface of the person's skin or hair, the fabric or color of clothing, scents emitting from personal cleansing products, lotions, and perfumes, and the like. As a result of an insect's attraction to these elements, people are naturally annoyed by pests during the course of a typical day. Additionally, insects and other pests frequently infect homes, schools, other buildings, gardens and farms as they continue their quests for food and shelter.

To mitigate the harmful effects and nuisance of such animals, various types of chemicals have been engineered to repel or kill them. These chemicals include insecticides and other pesticides to directly control the animals, herbicides or weed killers to destroy their habitats, and fungicides to control mold or mildew. Unfortunately, not only do these chemicals harm or kill animals who perform an integral role in the Earth's ecosystem, but these deadly poisons and hazardous chemicals also reap harm on the environment in general. Pesticides used on farms, for instance, contaminate the fields as well as underground water supplies. Moreover, pesticides represent leading contributors to air and water pollution, and in many cases, infect and poison the food that they are intended to protect from insects.

The dangers of pesticides, herbicides, fungicides, fertilizers and similar hazardous chemicals are well documented. By contaminating the environment or the food they are intended to protect, these chemicals can contribute to the development of a variety of human physiological illnesses. Prolonged exposure to pesticides has been known to manifest nasal congestion, headaches, a dry throat, respiratory infections, skin reactions, nervous system damage, endocrine disorders, increased sensitivity to other chemicals, and cancer.

In fact, scientists contend that some of the chemical compounds used in pesticides cause irreversible harm to human brain cells or neurons. A recent scientific study has revealed that individuals exposed to pesticides in the home or garden are 70% more likely to develop Parkinson's Disease than those who are not exposed. See “Pesticide exposure linked to Parkinson's disease,” Chubb Lucy. (Environmental News Network Inc., May 2000). Because of their smaller bodies and developing nervous and respiratory systems, children are even more vulnerable to the harmful effects of pesticides than adults. Yet, schools are commonly sprayed with herbicides and pesticides to control the likes of yellow jackets, ants, weeds, fleas, mosquitoes, flies, cockroaches, ants, wasps, mold, mildew, bacteria and rodents.

For example, organophosphates embody a commonly used class of pesticides. This chemical has been discovered to contribute to heart problems. Another commonly used substance around schools includes chlorpyifos that can fatally damage a child's nervous-system if inhaled in large doses. Another example is synthetic pyrethroids which include cypermethrin, a possible carcinogen. Diazinon, which is typically used on lawns, can cause nausea, dizziness, headaches and aching joints, and in large doses, can damage a child's nervous system. Other illness attributed to pesticides include childhood leukemia, soft-tissue sarcomas, brain cancers, asthma and other respiratory problems. See “Children face danger in the schoolyard grass from pesticides,” Daniella Brower. (Cable News Network, March 2000). In short, these deadly chemicals destroy the nervous systems of not only pests but humans as well. Hence, the extended use of pesticides creates a significant risk to public health.

As an alternative to chemical-based solutions, some scientists have revisited the laws of physics to use natural observations and experimentation to find healthier pest control methods. Through scientific observations, the inventors have discovered that insect spines, for example, are indeed real antenna that have properties comparable to dielectric antenna (e.g., plastic or polymeric substance). The inventors' research reveals that an insect's antennae functions similarly to a ten centimeter (cm) shortwave radar that can be used to smell the exhaust of electronics. In other words, an insect's antennae receives and processes electromagnetic radiation vibrating at a natural frequency signature.

Thus, by designing an apparatus capable of transmitting electromagnetic radiation within a desired frequency range, one can attract or repel insects and other pests. This concept is explored in commonly assigned U.S. Pat. No. 5,424,551 to Callahan, issued Jun. 13, 1995, and entitled “Frequency Emitter for Control of Insects” (hereinafter referred to as “the '551 patent”), and commonly assigned U.S. Pat. No. 5,528,049, issued Jun. 18, 1996, and entitled “Frequency Emitter for Control of Insects” (hereinafter referred to as “the '049 patent”). The disclosure of the '551 patent and the '049 patent is incorporated herein by reference as though set forth in its entirety.

The system described in the '551 patent utilizes natural or copied scatter surfaces, dielectric spine forms (representing, for example, an insect's sensilla), correct pumping radiations, and correct vibratory modulating frequency to generate coherent or semi-coherent frequencies to control or attract insects. The coherent or semi-coherent frequencies can act as either attractant radiation (e.g., trapping) or frequency quenching radiation (e.g., jamming). Similarly, the system of the '049 patent uses pumping radiation and either molecular vibratory modulation or a scatter surface to generate coherent or semi-coherent radiation frequencies to control or attract insects.

The inventors' research shows that the systems of the '551 patent or '049 patent work very well over short distances, but experiences power loss and becomes less efficient over larger ranges. Experiments by the inventors reveal that the trap of the '551 patent attracted moths over a four inch distance. This device functions as a flowing model that works very well over very short distances, but is inefficient because of power loss between the elements. The spacing between the components of the device are far apart, so a considerable amount of power is lost from component to component.

Consequently, a system and method are needed to solve the above-identified problems and provide an efficient solution for controlling insects and other pests in a manner that reduces pollution and medical risks.

### BRIEF SUMMARY OF THE INVENTION

The system and method of present invention overcome the problems of inefficient gaseous, pest control systems with minimum output by providing a paramagnetic-diamagnetic system as an efficient solid-state maser system that works over long distances. Moreover, the maser system is capable of controlling the amplification and direction of electromagnetic emissions from any molecular control system, such as a semiochemical (e.g., insect pheromones), garlic scent, perfume, deodorant, air freshener, similar molecules, infrared coded emissions from any system that controls or effects living organisms (such as, drugs, pharmaceuticals, etc.), and the like.

In an embodiment of the present invention, the maser system includes a layer of paramagnetic material. The paramagnetic layer can include any combination of andosite, basalt, granite, polyester film and other paramagnetic materials having a level of paramagnetism ranging from 1 to 14,000 centimeter-gram-seconds (cgs).

The paramagnetic layer is typically deposited onto a diamagnetic base that provides a housing or structural support for the maser system. The diamagnetic base can be composed of quartz, wood, plant fibers, leather, plastic, and other diamagnetic materials having a level of diamagnetism ranging from −1 to −4,000 cgs.

In an embodiment, a burlap or hairy cloth is soaked or impregnated with the molecular control system, and placed over the paramagnetic layer. The paramagnetic energy amplifies the molecular control system to produce coherent or semi-coherent electromagnetic emissions at a desired frequency, phase and direction.

In an embodiment, the electromagnetic emissions are modulated or tuned to the surrounding environment. The Callahan frequencies are used to modulate the solid-state maser system. The size of the maser system can also be adjusted to tune the maser system to match the resonant, paramagnetic atmospheric frequencies.

A feature of the present invention is that it provides an organic and biodegradable device for pest control. Furthermore, the device is designed to be tuned and modulated by existing and naturally occurring atmospheric frequencies.

An advantage of the present invention is that it provides a highly efficient and effective solution for maintaining pest populations below desired threshold levels and protecting food supplies without killing the animals, depleting the ozone layer or endangering the health of children and adults, alike.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. In the drawings, like reference numbers indicate identical or functionally similar elements. Additionally, the leftmost digit(s) of a reference number identifies the drawing in which the reference number first appears.

FIG. 1A illustrates a cross-sectional view, taken along a line 1-1 of FIG. 1B, of an paramagnetic-diamagnetic maser according to an embodiment of the present invention.

FIG. 1B illustrates a perspective view of the paramagnetic-diamagnetic maser of FIG. 1A.

FIG. 2 illustrates a flat plate configuration of a paramagnetic-diamagnetic maser according to an embodiment of the present invention.

FIG. 3 illustrates a loop configuration of a paramagnetic-diamagnetic maser according to an embodiment of the present invention.

FIG. 4 illustrates a loop configuration of a paramagnetic-diamagnetic maser according to another embodiment of the present invention.

FIG. 5 illustrates a rod configuration of a paramagnetic-diamagnetic maser according to an embodiment of the present invention.

### DETAILED DESCRIPTION OF THE INVENTION

### Table of Contents

I. Overview

II. System Architecture

III. Paramagnetic-Diamagnetic Maser Performance

IV. Conclusion

I. Overview

Throughout history, farmers have been known to distribute ground-up paramagnetic rock in their fields to revitalize the soil and stimulate plant or crop growth. Paramagnetic rock generally directs and amplifies organic energy in a single direction. The organic energy actually converges like a beam as it passes through a medium, such as the ground or air. Hence, this paramagnetic force functions as a magnetic modulator and stimulant for plant growth and increased agricultural output. As will be demonstrated below, the present invention is a paramagnetic-diamagnetic system that can be used to grow plants, as well as provide an organic, biodegradable solution for pest control without polluting the environment or increasing medical risks, and the like.

The paramagnetic-diamagnetic system of the present invention is a solid-state maser that is configurable to control the amplification and direction of electromagnetic waves over a wide band of frequencies, primarily in the radio, microwave and infrared spectrum, but including all regions of the frequency spectrum. More specifically, the system of the present invention controls the amplification and direction of electromagnetic radiation that is emitted from a molecular control system, such as a semiochemical, garlic scent, perfume, deodorant, air freshener, similar molecules, infrared coded emissions from any system that controls or effects living organisms (such as, drugs, pharmaceuticals, etc.), and the like. A semiochemical includes any secretory substance, such as insects pheromones, that regulates behavior in members of the same species.

A molecular control system (also referred to herein as “the control molecule”) contains ions whose energy levels can be shifted by a magnetic field. According to the present invention, the magnetic field is supplied by a paramagnetic force. In response to the application of the paramagnetic force, the molecular control system, in essence, can be modulated to amplify a desired frequency. This is accomplished by using a paramagnetic photon to induce the excited atom or molecule to shift energy states and, thereby, emit a photon of the same frequency as the paramagnetic photon. The emitted photon would also travel in the same direction and in phase with the paramagnetic photon. The amplitudes of the waves produced by the emitted and paramagnetic photons are aggregated to produce the amplification.

II. System Architecture

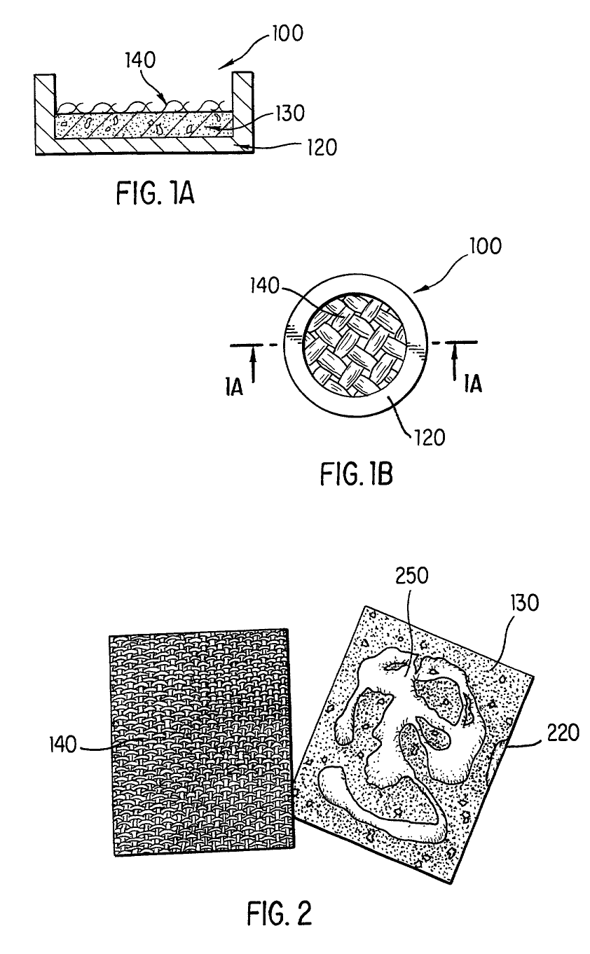

FIG. 1A and FIG. 1B illustrate a paramagnetic-diamagnetic maser 100 according to an embodiment of the present invention. As shown, FIG. 1B illustrates a top-down view of maser 100 and FIG. 1A illustrates a cross-sectional view taken along line 1-1 of FIG. 1B. Maser 100 is a central, conical radar dish type configuration that is tuned to the atmosphere. The components of maser 100 includes a diamagnetic base 120, paramagnetic layer 130 and cloth 140.

Diamagnetic base 120 provides a housing or structural support for the other components of maser 100. In an embodiment, diamagnetic base 120 is composed of quartz (e.g., sand). However, diamagnetic base 120 can be any type of diamagnetic material that is weakly repelled by the application of an external magnetic field. Such material includes, but is not limited to, wood, plant fibers, leather, plastic, and the like. In a preferred embodiment, the diamagnetism of diamagnetic base 120 ranges from −1 to −4,000 centimeter-gram-seconds (cgs). A tree, for example, typically averages −300 cgs. Most naturally occurring diamagnetic materials approximates −3,000 cgs.

Paramagnetic layer 130 is deposed over diamagnetic base 120. In an embodiment, paramagnetic layer 130 is a mixture of paramagnetic rock, including andosite, basalt, granite, and the like. In another embodiment, paramagnetic layer 130 is magnetic tape, which is generally a polyester film (such as, a Mylar® film available from DuPont) that is coated with a thin layer of plastic containing tiny permanent magnets. Paramagnetic layer 130 can include other types of paramagnetic material that are weakly pulled towards an applied external magnetic field.

In an embodiment, an adhesive composition is mixed with the paramagnetic material to produce paramagnetic layer 130. The adhesive composition can be any combination of materials that manifest the creation of a plastic-like insulation between paramagnetic layer 130 and diamagnetic base 120. The adhesive composition can include a combination of water and alcohol, but should not include solvents, such as, gasoline, methylene, ethylene, propylene and the like.

In an preferred embodiment, the dielectric constant for paramagnetic layer 130 ranges from 2.23 to 3.39 at 1,000 Hz. The dielectric constant is the ratio of the susceptibility or propensity for paramagnetic layer 130 to be magnetized in an external field to the susceptibility of a vacuum or free space. However, the dielectric constant can be approximated as the square of the refractive index of paramagnetic layer 130 (e.g., 1.5²). In a preferred embodiment, the paramagnetism ranges from 1 to 14,000 cgs. At levels exceeding 14,000 cgs, system performance starts to degrade. In an embodiment, ten cm of magnetic tape having ten cgs of paramagnetism works effectively.

Maser 100 also includes cloth 140, which is a burlap, hairy or other cloth soaked in the desired control molecule. Cloth 140 is preferably, but not necessarily, a photonic ionic cloth radio amplifier (PICRA) as described in commonly assigned U.S. Pat. No. 5,247,933, issued Sep. 28, 1993 to Philip S. Callahan and Harry Kornberg, and entitled “Photonic Ionic Cloth Radio Amplifier” (hereinafter referred to as “the '933 patent”). The disclosure of the '933 patent is incorporated herein by reference as though set forth in its entirety. As described in the '933 patent, PICRA is a burlap or other unbleached hairy cloth that directs molecules from the burlap threads into the atmosphere (or free space). As described in the '933 patent, the conductivity of cloth 140 can be increased by soaking cloth 140 in a saline solution for approximately one to six hours and then air dried until it is slightly damp. The saline solution preferably consists of an isotonic aqueous solution containing a borate buffer system and sodium chloride, preserved with 0.1% of sorbic acid and disodium (e.g., EDTA). Alternatively, four tablespoons of sea salt per half pint of water with the same borate buffer described above can be used. However if cloth 140 is very damp or completely dry, cloth 140 may not be as conductive. Nonetheless for the present invention, cloth 140 is not required to be conductive since maser 100 is not operated by a battery or electrical power source, and thus, cloth 140 can be completely dry.

Similarly, saline or sea water can be used to make paramagnetic layer 130 more conductive, but, once again, it is not required since the maser 100 does not require a battery or electrical power source. Nonetheless, the strength and longevity of a signal emitted from maser 100 can be increased by dampening cloth 140, paramagnetic layer 130, or both with water.

The control molecule is impregnated or soaked into the fibers of cloth 140. Alternatively, the control molecule can be placed into the paramagnetic-adhesive mixture of paramagnetic layer 130. Irrespectively, cloth 140 is disposed over paramagnetic layer 130 as shown in FIG. 1A. In a preferred embodiment, cloth 140 (impregnated with the control molecule) and paramagnetic layer 130 are both allowed to harden for at least twenty-four hours, prior to positioning cloth 140 over paramagnetic layer 130. An adhesive composition can be used to ensure that cloth 140 adheres to paramagnetic layer 130.

In an embodiment, electromagnetic emissions from maser 100 are varied or modulated by the 156.26 or 506.81 Hz atmospheric scatter frequencies (also referred to as the Callahan frequencies). These electromagnetic waves (i.e., the Callahan frequencies) are Cannabas scatter waves of the atmosphere and can be found, all over the world, penetrating both atmosphere and earth with little or no absorption. The Cannabas scatter waves are spaced by 156.26 Hz. However, 506.8 Hz has been determined by the inventors to be a natural harmonic of the 156.26 scatter frequency. Other harmonic frequencies of 156.26 can also be used. Thus, the emissions from maser 100 can be naturally modulated because the Callahan frequencies exists freely in nature.

In an embodiment, the electromagnetic emissions from maser 100 are tuned by applying or loading 3.2 cm or 10 cm high atmospheric, or cosmic, frequencies to the system. The 3.2 cm high waves are also found all over the world. They reflect from the ground, including sand or rock, and can be directed or amplified like a laser. The surrounding atmosphere is typically composed of oxygen which tends to be paramagnetic and self-modulating. One can easily observe that an oxygen-based atmosphere alters the frequency of visible electromagnetic radiation to produce a scattering or twinkling effect. This phenomenon can be evidenced by observing the twinkling of lights and distance stars. Thus, to improve the performance of maser 100, the electromagnetic waves radiating from maser 100 must be tuned to match the paramagnetic frequency of the surrounding atmosphere to reduce scatter or the twinkling effect. The resonant, paramagnetic frequency for oxygen is 3.2 cm high. Therefore, maser 100 is tuned to the atmosphere (i.e., 3.2 cm resonant air (i.e., oxygen) atmospheric region).

In an embodiment, maser 100 ranges between 1 to 6, preferably 1 to 2, wavelengths in diameter. This range enables maser 100 to match its emissions to the antenna emissions of the insect to be controlled. The inventors have discovered that a half or quarter wavelength in diameter is not sufficient for matching the insect's antennae. As well-known, the amplitude of a signal can be measured by the equation A=D÷λ₀, where D represents the diameter of the signal emitter and λ₀ is the free space wavelength. In a preferred embodiment, the amplitude of the signal from maser 100 should be 1 or 2 wavelengths. In other words, for a loading frequency of 3.2 cm in an oxygen-based atmosphere, the diameter of diamagnetic base 120 should be 3.2 cm for 1 wavelength (i.e., A=3.2÷3.2) or 6.4 cm for 2 wavelengths.(i.e., A=6.4÷3.2). Thus, the dimensions of maser 100, namely diamagnetic base 120, must be adjusted according to the resonant, atmospheric frequency (i.e., oxygen).

FIG. 2 illustrates flat plate type configuration of maser 100 according to an embodiment of the present invention. In this embodiment, diamagnetic base 220 is a flat surface formed in the shape of a polygon, as shown, or any other geometric shape. Diamagnetic base 220 provides structural support for paramagnetic layer 130. Cloth 140 is soaked in the control molecule and positioned over paramagnetic layer 130. An adhesive 250 can be applied to seal diamagnetic base 220 to paramagnetic layer 130. However, adhesive 250 is optional. Adhesive 250 can be any adhesive composition, as discussed in reference to FIG. 1A.

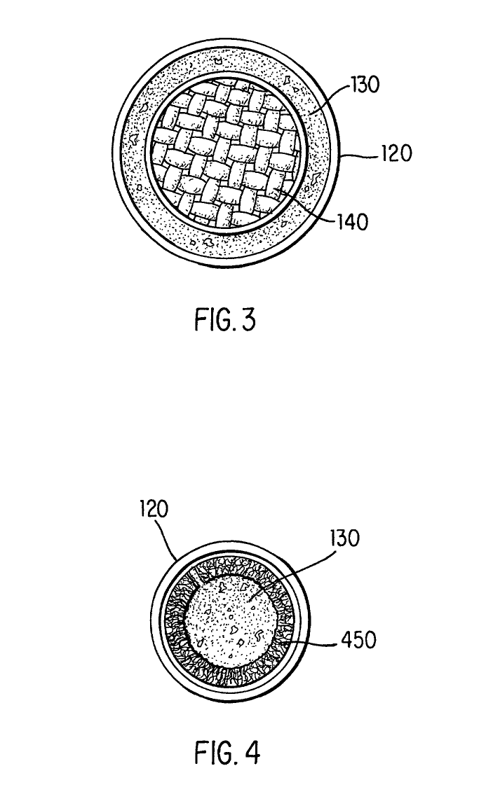

FIG. 3 illustrates a loop configuration similar to the embodiment shown in FIG. 1A. However, in this embodiment, cloth 140 is positioned in the center of diamagnetic base 120, and disposed directly onto diamagnetic base 120. Paramagnetic layer 130 surrounds cloth 140. An adhesive composition can be used to secure cloth 140 and paramagnetic layer 130 to diamagnetic base 120, but it is not required. As shown, a portion of diamagnetic base 120 forms a divider to separate paramagnetic layer 130 from cloth 140. However, the divider is optional.

In one embodiment, diamagnetic base 120 of FIG. 3 is red and, in a second embodiment, diamagnetic base 120 is blue. The inventors have discovered that a blue pumping color tends to attracts more insects. However, ants have a propensity to be more attractive to a red pumping color. Therefore, the color of maser 100, namely diamagnetic base 120, provides pumping radiation that improves the effectiveness of maser 100 to attract insects.

FIG. 4 illustrates another configuration of maser 100 that does not include cloth 140. In this embodiment, paramagnetic layer 130 is impregnated with the control molecule. Diamagnetic base 120 supports paramagnetic layer 130, but along the side wall of diamagnetic base 120 is a layer of dielectric spines 450, such as a spined plastic, velcro, and the like. Dielectric spines 450, thus, surround paramagnetic layer 130, and can be secured to diamagnetic base 120 by using an adhesive composition or other conventional methodologies for attaching components (including, but not limited to, brazing, soldering, welding, and the like) as would be apparent to one skilled in the relevant art(s). Alternatively, dielectric spines 450 need not be secured to diamagnetic base 120.

In this embodiment, photons of energy radiate from the control molecules or paramagnetic layer 130, and flow across dielectric spines 450. Spine collisions are formed by the spaces between the individual spines of dielectric spines 450 and the aligned control molecules. As the photons flow across the individual spines and through the spine collisions, the spine output (i.e., amount of radiation amplified by dielectric spines 450) is increased.

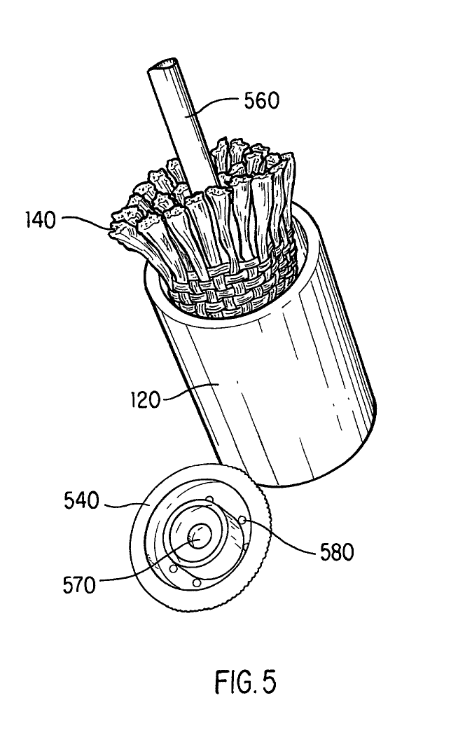

FIG. 5 illustrates an elongated rod configuration of maser 100 according to an embodiment of the present invention. In this embodiment, diamagnetic base 120 has a cylindrical shape. Cloth 140 lines the inner surfaces of diamagnetic base 120, and is soaked with the control molecule. Cloth 140 wraps around the base of a diamagnetic tube 560 that protrudes from the center of maser 100. In an embodiment, diamagnetic tube 560 is a plastic material. Diamagnetic tube 560 is filled with a paramagnetic material (not shown) similar to paramagnetic layer 130 described in reference to FIG. 1A. Also included is a lid 540 that fits over cloth 140 and can be fastened to diamagnetic base 120. A plurality of vent holes 580 are drilled into lid 540. Diamagnetic tube 560 extends through a tiny opening 570 in the center of lid 540.

The control molecules (e.g., scent) flows out of diamagnetic lid 540 along the paramagnetic material-filled diamagnetic tube 560 where the electromagnetic waves from the control molecules are trapped and highly amplified. The inventors have discovered that diamagnetic tube 560 functions as an antenna that continues to emit frequencies even after all of the control molecules (e.g., scent) have been dispersed. This is attributed to the monolayer of oriented molecules fixed on diamagnetic tube 560. When maser 100 is amplifying the signal from a scent molecule, the embodiment shown in FIG. 5 appears to be better suited for flying insects as opposed to ants or cockroaches. To attract mosquitoes, maser 100 should use a larger, black diamagnetic tube 560 filled with mosquito attractant and rock. The system should be modulated at a flickering rate (ELF) of 78.15 Hz harmonic and 156.26 Hz to attract the mosquito. It should be noted that 78.15 Hz is an echo or harmonic of the 156.26 Hz Callahan frequency.

III. Paramagnetic-Diamagnetic Maser Performance

As known to those skilled in the relevant art(s) when electronic components are closer together, zero aperture will occur. In a conventional radar system, zero aperture reduces the spreading of the radar beam so that, at the point of emission, the path length is shortened and produces phase conjugation. Thus, the system would be able to achieve almost complete spatial coherence.

As illustrated, maser 100 provides a solid-state system. In comparison with the system of the '551 patent or the '049 patent, the solid-state design of the present invention creates zero antenna aperture. The phase conjugation provided by this design improves performance, and increases power because the components are closer together and generate minimal loss or scatter. In other words, there is no spread of the maser beam, so that at the point of emission (i.e., zero aperture), the path length is so short (i.e., no spread) that phase conjugation, and complete spatial coherence can be achieved.

The system of the '551 patent uses paramagnetic (e.g., oxygen), diamagnetic (e.g., nitrogen) and contained scent in the form of a gas (e.g., atmosphere). The solid-state system of the present invention incorporates all the physical parameters of the gaseous system of the '551 patent, except, as in the case of any solid-state system, the paramagnetic-diamagnetic modulation is by a solid-state material (e.g., rock) which is substituted for the gas flowing air mixture. This allows a hairy cloth (e.g., simulating, for example, insect sensilla), or red-colored pumping radiation, to be incorporated directly into the paramagnetic-diamagnetic system without the necessity of flowing it. It also allows a reduction in size and form so that the three cm antenna dimensions can be matched to the three cm resonance of the surrounding air (e.g., oxygen). Therefore, unlike the system of the '551 patent, the system of the present invention is an efficient, solid-state maser system capable of working over longer distances.

It is possible that the desired frequency is not the only frequency emitted from maser 100. However, the emission of other frequencies is irrelevant to the effectiveness of the present invention. Nor is it relevant whether a few molecules (e.g., insect pheromones) can defuse through air spaces within diamagnetic base 120. In fact, if a few molecules escape through diamagnetic base 120, maser 100 functions as a more efficient device for, for example, attracting or repelling insects, because not only does maser 100 emit the desired frequency, but the escaped semiochemicals also produce emissions to lure or repel the insect in the general area. It is the inventors' belief that moths, and insects in general, are attracted or repelled by the electromagnetic radiation from pheromones, and not necessarily the pheromones, themselves. Therefore, the device of the present invention is primarily a frequency emitter that functions like a radar. With respect to pest control, the device of the present invention is configurable to increase the strength and longevity of a molecular control system (e.g., semiochemical and the like) that can be used to attract or repel the target pest.

Accordingly, the system and method of the present invention provide a highly efficient and effective solution for maintaining pest populations below desired threshold levels and protecting food supplies, without the use of hazardous pesticides. Moreover since the present invention promotes an cleaner technological alternative to pesticides, pests can be controlled without having to exterminate the animals, utilize ozone depleting or other environmentally harmful chemicals, or utilize pesticides that may endanger the health of children and adults, alike.

IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus, the present invention should not be limited by any of the above described exemplary embodiments, but should be defined only in accordance with the following claims and their equivalents.

What is claimed is:

1. A solid-state system for controlling electromagnetic emissions, comprising:
a diamagnetic base; and
a paramagnetic medium disposed to said diamagnetic base and coupled to a molecular control system, wherein said paramagnetic medium is operative to amplify or direct the electromagnetic emissions from said molecular control system into free space.

2. A system of claim 1, wherein the diamagnetism for said diamagnetic base ranges from −1 cgs to −4,000 cgs.

3. A system of claim 1, wherein the diameter of said diamagnetic base ranges from 3 cm to 10 cm.

4. A system of claim 1, wherein said diamagnetic base is composed of plastic.

5. A system of claim 1, wherein said diamagnetic base is composed of quartz.

6. A system of claim 1, wherein said diamagnetic base is composed of at least one of leather and plant fibers.

7. A system of claim 1, wherein said diamagnetic base is at least one of blue and red.

8. A system of claim 1, wherein said paramagnetic medium is composed of ground-up paramagnetic rock.

9. A system of claim 1, wherein said paramagnetic medium is composed of magnetic tape.

10. A system of claim 1, wherein said paramagnetic medium is composed of a polyester-based material.

11. A system of claim 1, wherein said paramagnetic medium is composed of at least one of andosite, basalt, and granite.

12. A system of claim 1, wherein the dielectric constant for said paramagnetic medium ranges from 2.23 to 3.39 at 1,000 Hz.

13. A system of claim 1, wherein the paramagnetism for said paramagnetic medium ranges from 1 cgs to 14,000 cgs.

14. A system of claim 1, wherein said molecular control system is selected from the group consisting of garlic, perfume, deodorant, semiochemical, and infrared coded emissions.

15. A system of claim 1, wherein said molecular control system is operative to attract or repel insects.

16. A system of claim 1, wherein the solid-state system is configured to produce electromagnetic emissions of 1 to 6 wavelengths, preferably 1 to 2 wavelengths.

17. A system of claim 1, further comprising a cloth coupled to said paramagnetic medium, wherein said molecular control system impregnates said cloth.

18. A system of claim 17, wherein said cloth is PICRA.

19. A system of claim 17, further comprising a paramagnetic tube extending outward from said diamagnetic base, wherein said paramagnetic medium is deposited within said paramagnetic tube, and wherein said cloth wraps around the lower part of said paramagnetic tube, so that the electromagnetic emissions flow out of said diamagnetic base along said paramagnetic tube.

20. A system of claim 1, wherein said molecular control system is distributed throughout said paramagnetic medium.

21. A system of claim 20, further comprising a layer of dielectric spines disposed between said diamagnetic base and said paramagnetic medium, wherein said paramagnetic medium directs or amplifies the electromagnetic emissions across said dielectric spines.

22. A system of claim 1, further comprising sticky paper impregnated with said molecular control system, wherein said diamagnetic base is position on said sticky paper.

23. A method for controlling electromagnetic emissions with a solid state system, comprising the steps of:
providing a diamagnetic base;
disposing a paramagnetic medium onto said diamagnetic base; and
coupling a molecular control system to said paramagnetic medium, such that said paramagnetic medium directs or amplifies the electromagnetic emissions from said molecular control system.

24. A method of claim 23, further comprising the step of modulating or tuning the electromagnetic emissions to the surrounding environment.

25. A method of claim 24, further comprising the step of applying Callahan frequencies to modulate the electromagnetic emissions.

26. A method of claim 24, further comprising the step of modulating the electromagnetic emissions at a frequency of 78.15, 156.26, or 506.81 Hz.

27. A method of claim 24, further comprising the step of tuning the electromagnetic emissions to match the resonant frequency for oxygen.

28. A method of claim 24, further comprising the step of tuning the electromagnetic emissions to match 3.2 cm or 10 cm high atmospheric frequencies.

29. A method of claim 23, further comprising the step of coupling a cloth to said paramagnetic medium, wherein said molecular control system impregnates said cloth.

30. A method of claim 23, further comprising the step of dampening at least one of said cloth and said paramagnetic medium to increase at least one of the longevity and the strength of the electromagnetic emissions.

31. A method of claim 23, further comprising the step of altering the color of said diamagnetic base to provide pumping radiation to the electromagnetic emissions.

32. A method of claim 23, further comprising the step of disposing a layer of dielectric spines, whereby spine collisions provided by said dielectric spines and said molecular control system increases the output of the electromagnetic emissions.
